(19) United States
(12) Patent Application Publication
(10) Pub. No.: US 2017/0209781 A1
(43) Pub. Date: Jul. 27, 2017

(54) Enhanced Security of Scratch-Off Products Using Homogenous Inks or Dyes

(71) Applicant: Mohawk Fine Papers, Inc., Cohoes, NY (US)

(72) Inventors: Gavin Lee Gaynor, Hudson Village, OH (US); Paul John Stamas, Troy, NY (US); Douglas Arthur Crane, Dalton, MA (US)

(21) Appl. No.: 15/186,240

(22) Filed: Jun. 17, 2016

Related U.S. Application Data
(60) Provisional application No. 62/286,713, filed on Jan. 25, 2016.

(51) Int. Cl. A63F 3/06

(52) U.S. Cl. CPC A63F 3/0665; A63F 3/0655

(57) ABSTRACT

In one embodiment, a scratch-off product with enhanced security comprises printing indicia and one or more other layers of the scratch-off product using inks and/or dies having the same or a similar chemical composition as the indicia to protect against attempts to view the hidden indicia without scratching-off the scratch-off coating. Printing the indicia and one or more layers of the scratch-off product using inks having the same or a similar chemical composition substantially reduces and/or eliminates the signal-to-noise ratio of the indicia relative to the other portions of the scratch-off product. In one embodiment, some or all of the layers of the scratch-off product are printed to cover the entirety of the scratch-off product increasing the efficiency of printing scratch-off products.

### CROSS REFERENCE TO RELATED APPLICATION

This application claims the benefit of U.S. Provisional Patent Application No. 62/286,713, entitled “Enhanced Security Instant Tickets Via Homogeneous Utilization Of Display, Overprint, Backing And Variable Indicia Inks or Dyes,” filed on Jan. 25, 2016. The subject matter of the related application is hereby incorporated by reference in its entirety.

### FIELD OF THE INVENTION

This invention generally relates to improving the security and aesthetics of products having indicia under a scratch-off-coating (SOC).

### BACKGROUND OF THE INVENTION

The concept of hiding indicia information under a SOC has been applied to numerous products, including, for example, lottery scratch-off tickets or instant games, commercial contests, telephone cards, gift cards, among many others (“scratch-off products”). Billions of scratch-off products are printed every year. Typically the indicia information (e.g., barcode, account number, win/loss information, or any other information hidden under a SOC) is the only information on a scratch-off product that is variable or different from ticket-to-ticket. For example, the variable indicia information on some scratch-off lottery tickets indicates a loss, while others indicate a free play or a win of a specified dollar amount. Aside from the variable indicia, every lottery ticket of a particular type typically looks identical.

The purpose of the SOC is to securely hide the indicia information of scratch-off products and ensure that the indicia cannot be read or decoded without removing the SOC. The SOC also ensures that the product has not been previously used, played, or modified. Typically the indicia is printed using a specialized high-speed inkjet printer with a water-soluble dye. The remaining layers of a scratch-off product are typically printed using flexography (i.e., a printing process that uses fixed plates) or gravure (i.e., a printing process that uses fixed cylindrical image carriers) due to the speed and reliability associated with printing a long run (e.g., millions of copies) of the same scratch-off product.

Fixed-plate printing requires using a different plate for each color separation or sub-layer of a scratch-off product. A traditional scratch-off product is composed of 21 layers as follows: four lower protection layers comprised of two black layers and two white layers; a four-color display consisting of images/text; indicia information; a two-layer protect and release coating; a SOC comprised of four protection layers (two black layers and two white layers) and a four-color overprint of images/text; and a two-color print of images/text displayed on the underside of the product. That means a traditional fixed-plate printing process requires 29 different plates to print a single scratch-off product. Due to the significant setup time, testing and verification to replace all of the plates within the press for printing different scratch-off products, there is a significant emphasis on reducing cost by printing long runs at high speeds. To be profitable, a typical fixed-plate scratch-off lottery ticket print run requires printing at least 10 million iterations at speeds between 600 and 1000 feet per minute (FPM). Because the indicia information is the only portion of a ticket that is variable, the indicia is printed with a digital printer. To accommodate the high-speed fixed-plate printing process, the indicia information of scratch-off products is typically printed using a high-speed inkjet printer, with an ink-jet dye that has a substantially different chemical composition from the inks used for the layers above and below the indicia, which are printed via fixed-plates using flexographic or gravure inks.

Individuals exploit the difference between the chemical composition of the inkjet colorant used to print indicia and the flexographic/gravure printed images to compromise the security features that hide the indicia information. If the indicia can be read or decoded without removing the SOC, individuals can identify winning lottery tickets and sell only losing tickets, use telephone cards and subsequently sell them as new, and so on. Various techniques are used to temporarily reveal the hidden indicia under the SOC of scratch-off products, which leave little or no trace that the scratch-off product was compromised.

Diffusion is one technique that reveals the hidden indicia under the SOC by applying a solvent (e.g., alcohol) to a scratch-off product. The solvent penetrates the upper layers of the scratch-off product and saturates the indicia dye and resin. The indicia dye is absorbed by the solvent, causing a portion of the indicia to diffuse through the upper layers of the scratch-off product, revealing a faint image of the underlying indicia. After the scratch-off product is allowed to dry, the faint image of the underlying indicia disappears from the face of the scratch-off product, leaving little to no trace that the indicia was identified via diffusion. Diffusion allows a user to generate a signal representative of the dye used for the indicia information relative to the sections of the scratch-off product surrounding the indicia—i.e., measuring a positive signal-to-noise ratio (SNR) identifying the hidden indicia without altering the SOC.

Another technique that reveals the hidden indicia under the SOC is inducing fluorescence. Fluorescence is induced by supplying light of a particular wavelength that causes the indicia dye to fluoresce. The fluorescing dye emits light having wavelengths that are characteristic of the chemical composition of the dye. The different ink used for sections of the scratch-off product surrounding the indicia either emit no light or light of a different wavelength from the indicia dye. The fluorescent light emitted by the indicia dye is then captured by using a digital camera with an optical filter that only allows fluorescent light of a narrow set of wavelengths to pass through the filter. Similar to diffusion, fluorescence allows a user to measure a positive SNR identifying the hidden indicia without altering the SOC.

Another technique involves applying an electrostatic charge to a scratch-off product. Applying an electrostatic charge to the scratch-off product may induce a differential charge in the indicia dye relative to the sections of the scratch-off product surrounding the indicia. An electrophotographically printed (e.g. dry toner) indicia would be particularly susceptible to this technique, as toner is specifically designed to carry charge as an essential part of the image creation process. If an electrostatically sensitive powder (e.g., baby powder) is applied over the SOC, the powder will align in the two-dimensional shape of the indicia under the SOC. Similar to diffusion and fluorescence, the electrostatic charge allows a user to measure a positive SNR identifying the hidden indicia without altering the SOC.

Another technique for viewing the hidden indicia information is mechanically lifting the SOC using a thin blade (e.g., an X-ACTO blade) or other device to peel back a portion of the SOC to reveal the hidden indicia. The SOC is then glued back into place to conceal that the SOC was lifted to view the indicia.

Over the last few decades, the scratch-off product industry has developed chemical barriers and has redesigned the SOC to resist known techniques for revealing the indicia. For example, the protect and release coat, which seals the indicia information and allows the SOC to scratch-off, has been modified to block known solvents from penetrating to the indicia. However, modifying the protect an d release coat to resist known diffusion attacks often requires use of costly chemical compounds and complex curing processes involving the use of ultraviolet light or an electron beam to cure the protect and release coat in a controlled environment. Further, the protect and release coat does not protect from diffusion techniques applied to the backside of a scratch-off product. Although the layers below the indicia may also include a barrier or seal for resisting diffusion, these lower layers typically provide less protection as they must provide an adequate surface for the upper layers of the scratch-off product to adhere to. The industry has added layers above and below the indicia to block predefined wavelengths (e.g. ultraviolet and infrared) indicative of the chemical composition of the indicia. The industry has also implemented anti-static barriers such as polymer films to resist electrostatic attempts to induce a differential charge in the indicia. The industry has also redesigned the SOC so that the coating crumbles or flakes (as opposed to peeling off in on piece), making it more difficult to conceal an attempt to mechanically lift the SOC to view the indicia

Yet, the scratch-off product industry continues to be challenged to address the problem of assisted mechanical lifts to view hidden indicia under the SOC. Assisted mechanical lifts involve applying a material to the SOC (e.g., clear acrylic coating) that strengthens the SOC and resists crumbling or flaking when a user attempts to mechanically lift the SOC. That means users can more easily glue the SOC into place, concealing the mechanical lift.

The scratch-off product industry also has not identified a solution for resisting all fluorescence attacks. The inkjet dye used for the printing the indicia is composed of compounds having high molecular mass that tend to fluoresce in response to a large number of wavelengths of light (e.g., 100,000 or more wavelengths may cause fluorescence). Thus, it is nearly impossible to design barriers that block every possible wavelength that can cause fluorescence in the indicia dye. Additionally, minute variations in the chemical composition of the indicia dye, which do not affect the appearance of the indicia and are considered acceptable for printing, may greatly alter the fluorescence characteristics of the indicia dye. Accordingly, wavelengths of light that did not cause fluorescence in previously tested indicia dye may result in fluorescence due to the minute variations in the chemical composition of the indicia dye. Even if reliable blocking layers are engineered to block nearly all wavelengths of light, digital cameras using long timed exposures and appropriately tuned narrow-band optical filters are capable of capturing minute emissions of fluorescence from the indicia dye, revealing the hidden indicia information.

Further, scratch-off products are still printed using indicia dye that has a different chemical composition from the inks used for the layers above and below the indicia. Because many of the various techniques for identifying hidden indicia information of a scratch-off product rely on the indicia dye having a different chemical composition from the inks used for the layers above and below the indicia, the possibility still remains that new techniques may be developed in the future for inducing diffusion, fluorescence, electrostatic charge, or some other characteristic feature to identify hidden indicia information.

Accordingly, there is an unmet demand for a method of efficiently printing scratch-off products that effectively resists known and unknown techniques for revealing the hidden indicia information and allows for improvements to the aesthetic design of scratch-off products.

### SUMMARY OF THE INVENTION

In one embodiment, a scratch-off product with enhanced security includes a substrate, indicia printed on a layer of the substrate, a protect and release layer printed above the indicia and a scratch-off coating printed above the protect and release layer. The scratch-off coating includes an upper opacity layer that has the same or a similar chemical composition as the indicia.

In one embodiment, the substrate includes a lower opacity layer that the covers the entirety of the substrate and the indicia is printed using the same or a similar chemical composition as the lower opacity layer. In one embodiment, the protect and release layer covers the entirety of the substrate. In another embodiment, the upper opacity layer covers the entirety of the substrate.

In one embodiment, the scratch-off coating further comprises an overprint layer printed above the upper opacity layer. The overprint layer has the same or a similar chemical composition as the indicia.

In one embodiment, the scratch-off product includes a display that has the same or a similar chemical composition as the indicia. In one embodiment, the display is printed on the same layer as the overprint layer. In another embodiment the display and indicia are printed on the same layer. In another embodiment, the display is printed on the substrate.

In one embodiment, a layer is printed on the backside of the substrate that has the same or a similar chemical composition as the indicia. In one embodiment, the indicia is comprised of a graphical image.

In one embodiment, a method of printing a scratch-off product with enhanced security includes feeding a substrate into a printing press, printing indicia on a layer of the substrate, printing a protect and release layer above the indicia, and printing a scratch-off coating above the protect and release layer, wherein the scratch-off coating includes a an upper opacity layer that has the same or a similar chemical composition as the indicia.

In one embodiment, the method further comprises printing a lower opacity layer on the substrate and printing the indicia using the same or a similar chemical composition as the lower opacity layer. In one embodiment, the method further comprises printing a layer on the backside of the substrate that has the same or a similar chemical composition as the indicia.

In one embodiment, the method further comprises printing the protect and release layer to cover the entirety of the substrate. In another embodiment, the method further comprises printing the upper opacity layer to cover the entirety of the substrate.

In one embodiment, the method further comprises printing an overprint layer above the upper opacity layer using the same or a similar chemical composition as the indicia. In one embodiment, the method further comprises printing a display above the lower opacity layer using the same or a similar chemical composition as the indicia.

### BRIEF DESCRIPTION OF THE FIGURES

FIG. 1 is a diagram of one embodiment of a scratch-off product with enhanced security.

FIG. 2 is a diagram of one embodiment of a scratch-off product with enhanced security.

FIG. 3 is a diagram of one embodiment of a scratch-off product with enhanced security.

FIG. 4 is a flowchart of steps for printing scratch-off products with enhanced security.

### DETAILED DESCRIPTION OF THE INVENTION

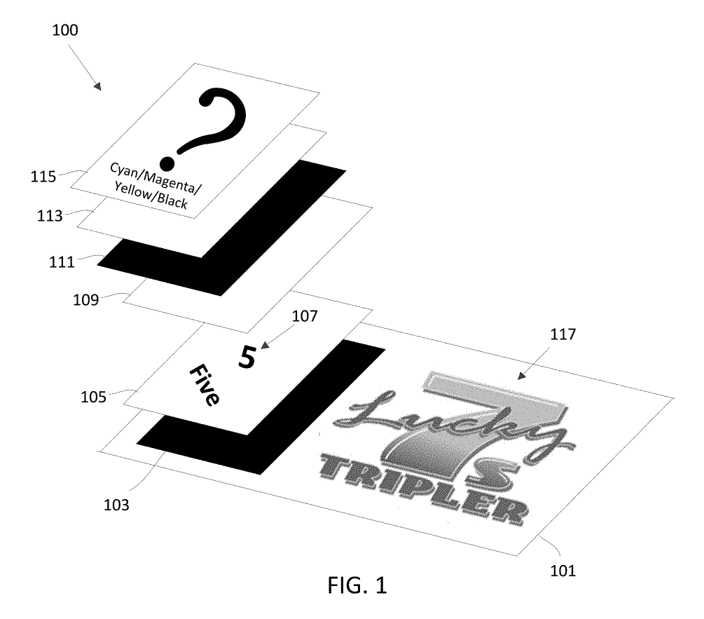

FIG. 1 is a diagram illustrating one embodiment of a scratch-off product with enhanced security. Scratch off-product 100 is printed on a substrate 101, which can be paper, plastic, foil, film or any other suitable material for printing. United States Provisional patent application entitled “Opaque/Non-Delamination Security Substrate,” filed on even date, discloses various types of substrate 101 that can be used for printing scratch-off products 100. The subject-matter of this related application is hereby incorporated by reference in its entirety.

A lower opacity layer 103 is printed over the substrate 101. The lower opacity layer 103 provides opacity in the area where indicia 107 will be printed in the upper layers of the scratch-off product 100. The lower opacity layer 103 can be printed using carbon black based ink, which absorbs light in the visible spectrum and the infrared spectrum, or can be a process black that combines magenta, yellow, and cyan (or any other combination of colors) to visually produce the color black. A lower opacity layer 103 composed of process black can be printed by layering each of the component color separations. Alternatively, a spot color of process black can be created, which includes the proper proportions of each color, allowing the process black to be printed to substrate 101 without layering the colors. The lower opacity layer 103 functions as a security barrier to shield against attempts to identify the hidden indicia information from the backside of scratch-off product 100. In a preferred embodiment, the lower opacity layer 103 comprises multiple layers, including, for example, one or more layers of carbon black and/or one or more layers of process black.

A lower background layer 105 is printed on lower opacity layer 103 to provide a grey or white contrasting background for printing indicia 107. Alternatively, the lower background layer 105 may comprise a color such as magenta, yellow, cyan or any combination thereof. The lower background layer 105 can be printed using a titanium dioxide based white ink. Titanium dioxide provides opacity in the visible spectrum by refraction and effectively absorbs ultraviolet light. Alternatively, any other ink can be used that is capable of creating a grey, white or colored background over lower opacity layer 103. Depending on the degree of contrast required for printing indicia 107, the lower background layer 105 may comprise multiple layers. For example, if only one layer of white ink is used for the lower background layer 105, the combination of white ink over lower opacity layer 103 may yield a color that is grey. If the desired color for lower background layer 105 is a bright white, additional layers of ink may need to be printed to achieve the desired color. In one embodiment, a layer of reflective foil may be applied over lower opacity layer 103 (not shown) to reduce the number of layers of ink needed to produce a bright white or colored lower background layer 105. In one embodiment, where a metallic appearance is desired, the layer of reflective foil applied over lower opacity layer 103 serves as the printable background layer 105 for the indicia. In an alternative embodiment, reflective foil may be used in place of the lower opacity layer 103. In one embodiment, a benday pattern consisting of varying lines (e.g., cyan, magenta or yellow) may be printed over lower background layer 105 (not shown).

Indicia 107 is printed over lower background layer 105. Because the indicia 107 is composed of variable information, indicia 107 is printed using a digital printer. In one embodiment, indicia 107 comprises a color such as magenta, yellow, cyan or any combination thereof (or any other combination of colors). Indicia 107 can be numerical, typographic, a graphical image, or any other type of indicia.

A protect and release layer 109 is printed over lower background layer 105 and indicia 107 to protect and seal the lower layers and allow all other layers applied on top of the protect and release layer 109 to scratch-off. The protect and release layer 109 is a translucent, scratch resistant, clear coat that may be tinted or colored. Typically protect and release layer 109 is composed of acrylic or polyurethane along with other additives depending on whether protect and release layer 109 will be dried/cured by convection, ultraviolet light, or an electron beam. Protect and release layer 109 can be comprised of any other compound that provides a clear coating that seals and protects the indicia (e.g., from mechanical damage or alteration or from chemical solvents penetrating through protect and release layer 109) and allows the SOC to be scratched off. Typically protect and release layer 109 is printed via an analog method such as flexography or gravure, but may also be printed digitally.

An upper opacity layer 111 is printed over protect and release layer 109. The colorants in upper opacity layer 111 are similar in composition to lower opacity layer 103 and function as a security barrier to shield against attempts to identify the hidden indicia information from the top of scratch-off product 100. Upper opacity layer 111 may contain other materials or an additional layer that works in conjunction with protect and release layer 109 to facilitate removal of upper opacity layer 111 when an individual scratches off the SOC. An upper background layer 113 is printed over upper opacity layer 111 to provide a grey, white or colored background for printing overprint 115. Upper background layer 113 is similar in composition and function to lower background layer 105. Overprint layer 115 is a colored image printed over upper background layer 113, typically composed of colors such as cyan, magenta, yellow, and black, or any combination thereof (or any combination of other colors). Similar to overprint layer 115, display layer 117 is a colored image printed on substrate 101 that may include graphics, instructions for the scratch-off product 100 or other information. Layers 111, 113 and 115 comprise the SOC of scratch-off product 100.

Layers 103, 105, 109, 111, 113, 115 and 117 can be printed using any combination of analog methods such as flexography, gravure, or any other fixed-plate printing process and/or digitally. Colors can be printed using spot colors, any combination of primary colors such as yellow, magenta, cyan and black, or any other combination of colors.

In one embodiment, indicia 107 and upper opacity layer 111 use inks having the same or a similar chemical composition (i.e., the same inks or dyes, colorants, ink resins and charge control agents). For example, if indicia 107 is comprised of carbon black ink, upper opacity layer 111 may also be comprised of carbon black ink. If indicia 107 is comprised of primary colors such as magenta, yellow or cyan (or any combination of other colors), upper opacity layer 111 may be comprised of the same or similar color inks or a process black (comprised of a combination of the same or similar primary color inks). In a preferred embodiment, upper opacity layer 111 is comprised of one or more carbon black ink layers and one or more process black ink layers, effectively providing an upper opacity layer 111 containing every possible combination of colorants that may be used for indicia 107.

If indicia 107 and upper opacity layer 111 are comprised of inks having the same or a similar chemical composition, it is difficult to detect indicia 107 from the top of the scratch-off product 100 using techniques such as diffusion, fluorescence and electrostatic charge as indicia 107 and the upper opacity layer 111 respond in the same or a similar way. For example, if indicia 107 is magenta and upper opacity layer 111 is comprised of process black (i.e., a combination of magenta, yellow and cyan), a solvent used for diffusion would result in both the magenta indicia 107 and the magenta dispersed throughout the upper opacity layer 111 diffusing through layers 113 and 115 of scratch-off product 100. In this case, diffusion would result in displaying a ghost image that appears to be the same shape and size as the upper opacity layer 111 and fails to identify indicia 107. An attempt to induce fluorescence using light having a particular set of wavelengths would result in both the indicia 107 and the upper opacity layer 111 emitting fluorescent light of the same wavelengths, making it difficult to discern the indicia 107 from the upper opacity layer 111. Further, an attempt to use to electrostatic charge would fail to induce a differential voltage between the indicia 107 and upper opacity layer 111. Rather, indicia 107 and upper opacity layer 111 may develop the same differential charge relative to the remainder of the scratch-off product 100, and use of electrostatic powder (e.g., baby powder) would align in the two-dimensional shape of upper opacity layer 111, failing to reveal indicia 107. In each case, diffusion, fluorescence and electrostatic charge, the SNR between the indicia 107 and any layer containing ink having the same or a similar chemical composition is greatly reduced. Similarly, indicia 107 and lower opacity layer 103 can be comprised of inks having the same or a similar chemical composition, making it more difficult to detect the indicia 107 from the backside of the scratch-off product 100.

In one embodiment, indicia 107 and overprint layer 115 are comprised of inks having the same or a similar chemical composition, reducing the SNR of indicia 107 from the top of scratch-off product 100. Additionally, overprint layer 115 may include graphics similar to indicia 107 that are strategically aligned with the indicia 107, further reducing the SNR of indicia 107. Because overprint layer 115 typically includes decorative graphics, which vary in shape and color from the indicia 107, overprint layer 115 does not fully mask or block an attempt to view indicia 107. In one embodiment, overprint layer 115 includes the winning indicia in the same location as indicia 107. For example, if scratch-off product 100 is a lottery ticket and the lottery instructions state that winning indicia 107 would be the presence of the number “5” and the word “Five” and losing indicia would be the absence thereof, the overprint layer 115 may include both the number “5” and the word “Five” in the same area as the underlying indicia 107, even if indicia 107 is a losing (i.e., absent) indicia. Similarly, indicia 107 and the images/text printed on the backside of substrate 101 can be comprised of inks having the same or a similar chemical composition, reducing the SNR of indicia 107 from the backside of the scratch-off product 100.

In one embodiment, indicia 107 and display 117 are comprised of inks having the same or a similar chemical composition. Because display 117 may cover all areas of the scratch-off product 100 except indicia 107, the indicia 107 and display 117 may be printed at the same time such that indicia 107 and display 117 are incorporated within the color separations. Although the display 117 is not above or below indicia 107, using the same or a similar chemical composition for the indicia 107 and display 117, by using different proportions of the same or a similar colorant, allows for further reduction of the SNR between indicia 107 and the surrounding display 117. For example, if indicia 107 (e.g., the number “5” and the word “five) is printed using 100% magenta and the portion of display 117 surrounding indicia 107 is printed using 50% magenta, the SNR ratio of indicia 107 relative to display 117 is significantly lower than if display 117 contained no magenta. Any proportion of the same or a similar colorant can be used to reduce the SNR between indicia 107 and the surrounding display 117. However, it is desirable to select proportions of the same colorant for the indicia 107 and the surrounding display 117 that allow the indicia to be read once the SOC has been removed. Simultaneously printing the indicia 107 and display 117 also enables the use of subtle indicia embedded within display 117. In one embodiment, display 117 may comprise a photographic image of a face in the area covered by the SOC, and indicia 107 may be a smile or a frown digitally superimposed on the same face to indicate, for example, a winning or losing lottery ticket. Such a subtle indicia is clearly visible when the SOC is removed, but is very difficult to detect without removing the SOC.

The embodiments described with respect to FIG. 1 can be combined in various ways, including, for example, printing some or all of layers 101 (backside of substrate), 103, 111, 115 and 117 using inks having the same or a similar chemical composition as indicia 107. Unlike prior art solutions developed to block the use of specific techniques under predefined conditions (e.g., layers that block or attenuate specific solvents known to cause diffusion, layers that block or attenuate specific wavelengths of fluorescent light, and anti-static layers that block or attenuate electrostatic charge) to view indicia 107, the embodiments of FIG. 1 effectively protect against known and unknown techniques to view indicia 107 by reducing and/or eliminating the SNR of indicia 107 relative to the other portions of the scratch-off product 100. The embodiments of FIG. 1 improve upon prior art solutions by causing the indicia 107 to emit signals that are the same or similar to the signals generated by other portions of the scratch-off product 100. Additionally, the use of full color graphics for indicia 107 presents a significant aesthetic improvement to the design of scratch-off product 100 compared to the simple numerical/typographic indicia used for prior art scratch-off products.

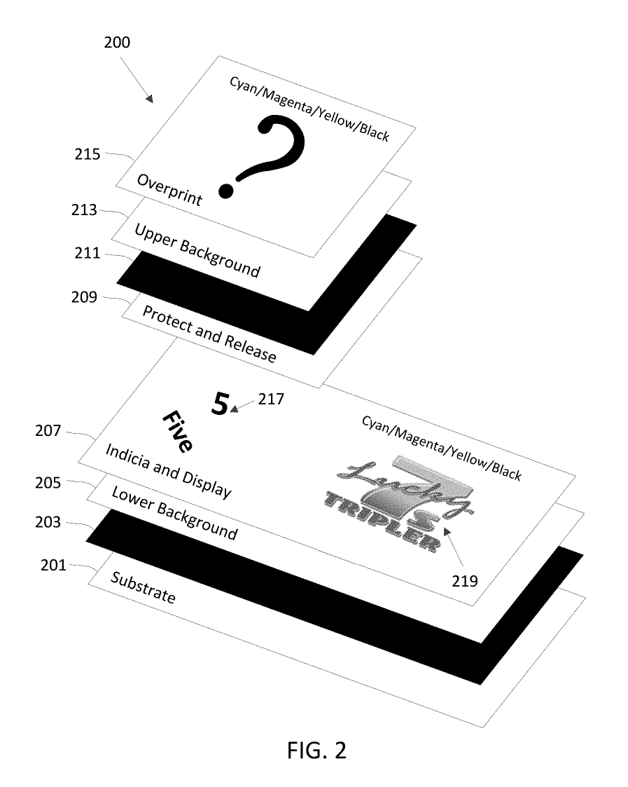

FIG. 2 is a diagram illustrating one embodiment of a scratch-off product with enhanced security 200. Scratch off-product 200 is printed on a substrate 201, which can be paper, plastic, foil, film or any other suitable material for printing.

A lower opacity later 203 is printed to cover all of substrate 201. Lower opacity layer 203 provides opacity in the area where indicia 217 will be printed in the upper layers of the scratch-off product 200. Lower opacity layer 203 can be printed using carbon black based ink and/or process black. Lower opacity layer 203 functions as a security barrier to shield against attempts to identify the hidden indicia information from the backside of scratch-off product 200. In one embodiment, lower opacity layer 203 can comprise multiple layers, including, for example, one or more layers of carbon black and/or one or more layers of process black.

A lower background layer 205 is printed to cover all of lower opacity layer 203 to provide a grey or white contrasting background for printing indicia 217 and display 219. Alternatively, the lower background layer 205 may comprise a color such as magenta, yellow, cyan or any combination thereof. The lower background layer 205 can be printed using a titanium dioxide based ink. Alternatively, any other ink can be used that is capable of creating a grey, white or colored background over lower opacity layer 203. Depending on the degree of contrast required for printing indicia 217 and display 219, the lower background layer 205 may comprise multiple layers. For example, if only one layer of white ink is used for the lower background layer 205, the combination of white ink over lower opacity layer 203 may yield a color that is grey. If the desired color for lower background layer 205 is a bright white, additional layers of ink may need to be printed to achieve the desired color. In one embodiment, a layer of reflective foil may be applied over lower opacity layer 203 (not shown) to reduce the number of layers of ink needed to produce a bright white or colored lower background layer 205. In one embodiment, where a metallic appearance is desired, the layer of reflective foil applied over lower opacity layer 203 serves as the printable lower background layer 205 for the indicia. In an alternative embodiment, reflective foil may be used in place of the lower opacity layer 203. In one embodiment, a benday pattern consisting of varying lines (e.g., cyan, magenta or yellow) may be printed over lower background layer 205 (not shown).

Although printing lower opacity layer 203 and lower background layer 205 across the entirety of substrate 201 results in the use of additional ink (opposed to confining layers 203 and 205 to the area where indicia 217 will be printed as in FIG. 1), this configuration results in simpler and more efficient printing of scratch-off products 200. Confining lower opacity layer 203 and lower background layer 205 to cover only the area where indicia 217 will be printed requires changing the flexographic plates and/or gravure cylinders for layers 203 and 205 each time a scratch-off product with a different indicia and SOC is printed (i.e., the size and location of the indicia and SOC may vary for different scratch-off products). Printing layers 203 and 205 to cover all of substrate 201 streamlines the printing process for all scratch-off products 200 as the same flexographic plates and/or gravure cylinders can be used for all scratch-off products 200 regardless of the shape, size or location of indicia 217 on scratch-off product 200. Alternatively, lower opacity layer 203 and lower background layer 205 may be printed digitally.

Indicia 217 and display 219 are printed simultaneously as part of an indicia and display layer 207 over lower background layer 205. Printing indicia 217 and display 219 at the same time allows the incorporation of indicia 217 in the color separations of display 219. Although the display 219 is not above or below indicia 217, using the same or a similar chemical composition for the indicia 217 and display 219, by using different proportions of the same or a similar colorant, allows for reduction of the SNR between indicia 217 and display 219. For example, if indicia 217 is printed using 100% magenta and the portion of display 219 that surrounds indicia 217 is printed using 50% magenta, simultaneously printing the indicia 217 and display 219 allows incorporating the 100% magenta indicia within the 50% magenta display. Any proportion of the same or a similar colorant can be used to reduce the SNR between indicia 217 and display 219. Typically display layer 219 is a colored image that may include graphics, instructions for the scratch-off product 200 or other information. In one embodiment, indicia 217 comprises a color such as magenta, yellow, cyan or any combination thereof (or any other combination of colors) and display 219 comprises similar colors as indicia 217.

A protect and release layer 209 is printed over indicia and display layer 207 to protect and seal the lower layers and allow all other layers applied on top of the protect and release layer 209 to scratch-off. The protect and release layer 209 can be confined to the area where indicia 217 is printed. Alternatively, protect and release layer 209 may be printed to cover all of indicia and display layer 207 (not shown) to streamline the printing process for protect and release layer 209. Similar to lower opacity layer 203 and lower background layer 205, printing protect and release layer 209 to cover all of indicia and display layer 207 results in simpler and more efficient printing of scratch-off products 200 as the same flexographic plates and/or gravure cylinders can be used for all scratch-off products 200 regardless of the shape, size or location of indicia 217 on scratch-off product 200. Protect and release layer 209 may also be printed digitally. Protect and release layer 209 is a translucent, scratch resistant, clear coat that may be tinted or colored. Typically, protect and release layer 209 is composed of acrylic or polyurethane along with other additives depending on whether protect and release layer 209 will be dried/cured by convection, ultraviolet light or an electron beam. Protect and release layer 209 can be comprised of any other compound that provides a clear coating that seals and protects the indicia (e.g., from mechanical damage or alteration or from chemical solvents penetrating through protect and release layer 209) and allows the SOC to be scratched off. It may not be preferable to print protect and release layer 209 across all of indicia and display layer 207 if the aesthetic design of scratch-off product 200 does not allow for having a shiny or glossy protect and release layer 209 over display 219.

An upper opacity layer 211 is printed over protect and release layer 209. The colorants in upper opacity layer 211 are similar in composition to lower opacity layer 203 and function as a security barrier to shield against attempts to identify the hidden indicia information from the top of scratch-off product 200. Upper opacity layer 211 may contain other materials or an additional layer that works in conjunction with protect and release layer 209 to facilitate removal of upper opacity layer 211 when an individual scratches off the SOC. Upper opacity layer 211 is confined to the area where indicia 217 is printed on scratch-off product 200 so that the upper opacity layer 211 does not cover display 219 printed on indicia and display layer 207. An upper background layer 213 is printed over upper opacity layer 211 to provide a grey, white or colored background for printing overprint layer 215. Upper background layer 213 is similar in composition and function to lower background layer 205 but is confined to the area where upper opacity layer 211 is printed so that it does not cover display 219 printed on indicia and display layer 207. Overprint layer 215 is a colored image printed over upper background layer 213, typically composed of colors such as cyan, magenta, yellow, and black, or any combination thereof (or any combination of other colors). In one embodiment, overprint layer 215 can be printed across all of scratch-off product 200, covering upper background layer 213 and display 219 on indicia and display layer 207 (not shown). In one embodiment, the portion of overprint layer 215 covering display 219 could compose additional graphic details for display 219. Alternatively, overprint layer 215 could be a complete reprint of display 219 to provide a continuous appearance to the final printed layer of scratch-off product 200 and conceal all of protect and release layer 209. Concealing all of protect and release layer 209 with a continuous overprint layer 215 would also help secure scratch-off product 200 from any attempted unassisted or assisted mechanical lift by providing a continuous layer that conceals the boundary of the SOC (i.e., layers 211, 213 and 215 in the area covered by protect and release layer 209). Further, a benday pattern consisting of fine lines could be printed across overprint layer 215 (not shown), which would require cutting through and distorting the fine lines to mechanically lift the SOC and identify indicia 217. The distorted lines would indicate that a mechanical lift was attempted.

Layers 203, 205, 209, 211, 213 and 215 can be printed using any combination of analog methods such as flexography, gravure, or any other fixed-plate printing process and/or digitally. Colors can be printed using spot colors, any combination of primary colors such as yellow, magenta, cyan and black, or any other combination of colors. Protect and release layer 209 is typically printed using flexography or gravure, but can also be printed digitally. Further, as discussed with respect to the embodiments of FIG. 1, some or all of layers 201 (backside of substrate), 203, 207 (including display 219), 211 and 215 can be printed using inks having the same or a similar chemical composition as indicia 217.

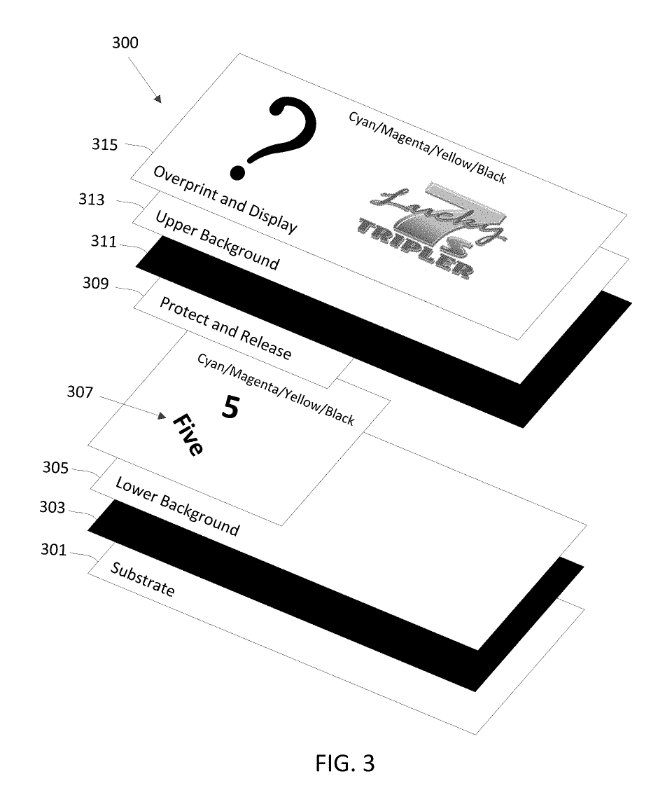

FIG. 3 is a diagram illustrating one embodiment of a scratch-off product with enhanced security 300. Scratch off-product 300 is printed on a substrate 301, which can be paper, plastic, foil, film or any other suitable material for printing.

A lower opacity later 303 is printed to cover all of substrate 301. Lower opacity layer 303 provides opacity in the area where indicia 307 will be printed in the upper layers of the scratch-off product 300. Lower opacity layer 303 can be printed using carbon black based ink and/or can be a process black. Lower opacity layer 303 functions as a security barrier to shield against attempts to identify the hidden indicia information from the backside of scratch-off product 300. In one embodiment, lower opacity layer 303 can comprise multiple layers, including, for example, one or more layers of carbon black and/or one or more layers of process black.

A lower background layer 305 is printed to cover all of lower opacity layer 303 to provide a grey or white contrasting background for printing indicia 307. Alternatively, lower background layer 305 may comprise a color such as magenta, yellow, cyan or any combination thereof (or any combination of other colors). Lower background layer 305 can be printed using a titanium dioxide based ink. Alternatively, any other ink can be used that is capable of creating a grey, white or colored background over lower opacity layer 303. Depending on the degree of contrast required for printing indicia 307, the lower background layer 305 may comprise multiple layers. For example, if only one layer of white ink is used for the lower background layer 305, the combination of white ink over lower opacity layer 303 may yield a color that is grey. If the desired color for lower background layer 305 is a bright white, additional layers of ink may need to be printed to achieve the desired color. In one embodiment, a layer of reflective foil may be applied over lower opacity layer 303 (not shown) to reduce the number of layers of ink needed to produce a bright white or colored lower background layer 305. In one embodiment, where a metallic appearance is desired, the layer of reflective foil applied over lower opacity layer 303 serves as the printable background layer 305 for the indicia. In an alternative embodiment, reflective foil may be used in place of the lower opacity layer 303. In one embodiment, a benday pattern consisting of varying lines (e.g., cyan, magenta or yellow) may be printed over lower background layer 305 (not shown).

Although printing lower opacity layer 303 and lower background layer 305 across the entirety of substrate 301 results in the use of additional ink (opposed to confining layers 303 and 305 to the area where indicia 307 will be printed as in FIG. 1), this configuration results in simpler and more efficient printing of scratch-off products 300. Confining lower opacity layer 303 and lower background layer 305 to cover only the area where indicia 307 will be printed requires changing the flexographic plates and/or gravure cylinders for layers 303 and 305 each time a different scratch-off product 300 is printed. Printing layers 303 and 305 to cover all of substrate 301 streamlines the printing process for all scratch-off products 300 as the same flexographic plates and/or gravure cylinders can be used for all scratch-off products 300 regardless of the shape, size or location of indicia 307 on scratch-off product 300. Alternatively, layers 303 and 305 can be printed digitally.

Indicia 307 is printed over lower background layer 305. In one embodiment, indicia 307 comprises a color such as magenta, yellow, cyan or any combination thereof (or any other combination of colors). In one embodiment, indicia 307 (e.g., the number “5” and the word “Five”) may be printed using 100% magenta and the area surrounding indicia 307 may be printed using 50% magenta to reduce the SNR between indicia 307 and the area surrounding indicia 307. Any proportion of the same or a similar colorant can be used to reduce the SNR between indicia 307 and the area surrounding indicia 307.

A protect and release layer 309 is printed over indicia 307 to protect and seal the lower layers and allow all other layers printed on top of the protect and release layer 309 to scratch-off. The protect and release layer 309 can be confined to the area where indicia 307 is printed. Alternatively, protect and release layer 309 can be printed to cover all of scratch-off product 300 (not shown) to streamline the printing process for protect and release layer 309. Similar to lower opacity layer 303 and lower background layer 305, this configuration results in simpler and more efficient printing of scratch-off products 300 as the same flexographic plates and/or gravure cylinders can be used for all scratch-off products 300 regardless of the shape, size or location of indicia 307 on scratch-off product 300. Protect and release layer 309 may also be printed digitally. The protect and release layer 309 is a translucent, scratch resistant, clear coat that may be tinted or colored. Typically, protect and release layer 309 is composed of acrylic or polyurethane along with other additives depending on whether protect and release layer 309 will be dried/cured by convection, ultraviolet light or an electron beam. Protect and release layer 309 can be comprised of any other compound that provides a clear coating that seals and protects the indicia (e.g., from scratching off or from chemical solvents penetrating through protect and release layer 209) and allows the SOC to be scratched off.

An upper opacity layer 311 is printed over protect and release layer 309 and covers all of scratch-off product 300. The colorants in upper opacity layer 311 are similar in composition to lower opacity layer 303 and function as a security barrier to shield against attempts to identify the hidden indicia information from the top of scratch-off product 300. Upper opacity layer 311 may contain other materials or an additional layer that works in conjunction with protect and release layer 309 to facilitate removal of upper opacity layer 311 when an individual scratches off the SOC. An upper background layer 313 is printed over the entirety of upper opacity layer 311 to provide a grey, white or colored background for printing overprint and display layer 315. Upper background layer 313 is similar in composition and function to lower background layer 305. Similar to layers 303, 305, and 309, printing upper opacity layer 311 and upper background layer 313 to cover the entirety of scratch-off product 300 streamlines the printing process such that the same flexographic plates or gravure cylinders can be used to print every scratch-off product 300 regardless of the size, shape or location of indicia 307. Alternatively, layers 311 and 313 may be printed digitally.

Overprint and display layer 315 is printed over upper background layer 313 and can be comprised of graphics, instructions for the scratch-off product 300 and/or other information. Overprint and display layer 315 is typically composed of colors such as cyan, magenta, yellow, and black, or any combination thereof (or any combination of other colors). Because overprint and display layer 315 covers all of scratch-off product 300, overprint and display layer 315 helps secure scratch-off product 300 from any attempted unassisted or assisted mechanical lift by providing a continuous layer that conceals the boundary of the SOC (i.e., layers 311, 313 and 315 in the area covered by protect and release layer 309). Further, fine lines could be printed across overprint and display layer 315 (not shown), which would require cutting through and distorting the fine lines to mechanically lift the SOC and identify indicia 307. The distorted lines would indicate that a mechanical life was attempted. In one embodiment, the area surrounding indicia 307 may extend across all of scratch-off product 300 covering the entirety of lower background layer 305, helping conceal the size and location of the indicia 307 on scratch-off product 300.

Layers 303, 305, 309, 311, 313 and 315 can be printed using any combination of analog methods such as flexography, gravure, or any other fixed-plate printing process and/or digitally. Colors can be printed using spot colors, any combination of primary colors such as yellow, magenta, cyan and black, or any other combination of colors. Further, as discussed with respect to the embodiments of FIG. 1, some or all of layers, 301 (backside of substrate), 303, 311 and 315 and the area surrounding indicia 307 can be printed using inks having the same or a similar chemical composition as indicia 307.

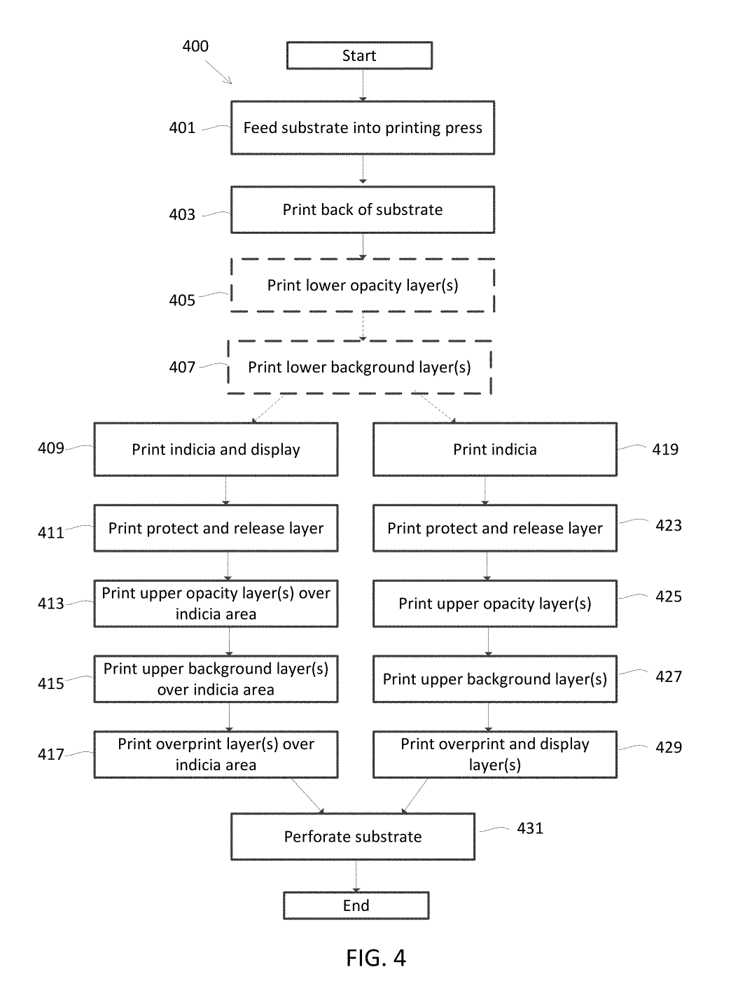

FIG. 4 is a flowchart of steps 400 for printing scratch-off products with enhanced security, as described above. At step 401, substrate is fed into a printing press comprised of one or more printers for printing the various layers of a scratch-off product, including, for-example, scratch-off products 100, 200 and 300 described with respect to FIGS. 1, 2 and 3 above.

At step 403, information is printed on the back of substrate 101, 201 or 301. In a preferred embodiment, the back of substrate 101, 201 or 301 is printed using inks having the same or a similar chemical composition as the inks used to perform steps 403, 405 and 407. In one embodiment, step 403 is performed using flexographic plates and/or gravure cylinders that use inks having the same or a similar chemical composition as the inks used to perform steps 405, 409 and 419. Although method steps 400 describe printing the back of substrate at step 403, this step can be performed at any time between steps 401 and 431. However, performing step 403 any time after step 405 would require flipping the substrate twice, as opposed to flipping the substrate only once at the beginning of the process.

At step 405, the substrate is flipped and the lower opacity layer(s) 103, 203 or 303 are printed on substrate 101, 201 or 301, which may be comprised of carbon black and/or process black. In a preferred embodiment, lower opacity layer(s) 103, 203 or 303 are comprised of one or more layers of carbon black and one or more layers of process black, effectively masking any color used for indicia 217. At step 407, the lower background layer(s) 105, 205 or 305 are printed over lower opacity layer(s) 103, 203 or 303, which may be comprised of white ink or colored ink. In one embodiment, the substrate that is fed into the printing press at step 401 already includes the lower opacity layer(s) and the lower background layer(s). Accordingly, in this embodiment, steps 405 and 407 are not performed and the method steps 400 proceed directly from step 403 to step 409 or step 419.

At step 409, indicia and display layer 207 is simultaneously printed on scratch-off product 200. Indicia 217 is printed using inks have the same or a similar chemical composition as lower opacity layer(s) 203. In one embodiment, display 219 may include an area that surrounds indicia 217 with a different proportion of the same or a similar colorant as the colorant used for indicia 217. For example, display 219 may comprise 50% magenta and indicia 217 may comprise 100% magenta. In one embodiment, one printer can be used to perform all of steps 405, 407 and 409. In another embodiment, any number and any combination of flexographic plates, gravure cylinders and/or digital printers may be used to perform steps 405, 407 and 409. In a preferred embodiment, one printer can be used to perform steps 405 and 407 and a second printer can be used to perform step 409 to increase the overall speed of printing scratch-off product 200. For example, if step 405 involves printing two layers (carbon black and process black), step 407 involves printing two layers of white and step 409 involves printing four layers (cyan, magenta, yellow, and black), a total of 8 layers must be printed to perform steps 405, 407, and 409. By performing steps 405 and 407 with one printer, and step 409 with a second printer, the printing speed is doubled as each printer is responsible for printing 4 layers (compared to using a single printer to print all 8 layers).

At step 411, protect and release layer 209 is printed over the portion of scratch-off product 200 containing indicia 217. In a preferred embodiment, at step 411, protect and release layer 209 is printed over the entirety of scratch-off product 200, covering indicia 217 and display 219. In one embodiment, protect and release layer 209 is printed using a flexographic plate or a gravure cylinder and may be cured by convection, ultraviolet light or an electron beam.

At step 413, upper opacity layer(s) 211 are printed over the portion of scratch-off product 200 containing indicia 217. Upper opacity layers(s) 211 may be comprised of one or more layers of carbon black and/or one or more layers of process black. In a preferred embodiment, upper opacity layer(s) 211 are comprised of both carbon black and process black, effectively masking any color used for indicia 217. At step 415, the upper background layer(s) 213 are printed over upper opacity layer(s) 211 (over the portion of scratch-off product 200 containing indicia 217), which may be comprised of white ink or colored ink.

At step 417, overprint layer 215 is printed over upper background layer(s) 213 (over the portion of scratch-off product 200 containing indicia 217). In one embodiment, overprint layer 215 extends across the entirety of scratch-off product 217. In a preferred embodiment, one printer can be used to perform all of steps 413, 415 and 417 using inks having the same or a similar chemical composition as the printer used to perform steps 405, 407 and 409. In another embodiment, any number and any combination of flexographic plates, gravure cylinders and/or digital printers may be used to perform steps 413, 415 and 417. In a preferred embodiment, one printer is used to perform steps 413 and 415 and a second printer is used to perform step 417 to increase the speed of performing steps 413, 415 and 417.

At step 419, indicia 107 or 307 is printed on scratch-off product 100 or 300. Indicia 107 or 307 is printed using inks have the same or a similar chemical composition as lower opacity layers 103 and 303. In one embodiment, the area surrounding indicia 107 or 307 may comprise 50% magenta and indicia 107 or 307 may comprise 100% magenta. In one embodiment, one printer can be used to perform all of steps 405, 407 and 419. In another embodiment, any number and any combination of flexographic plates, gravure cylinders and/or digital printers may be used to perform steps 405, 407 and 419. In a preferred embodiment, one printer is used to perform steps 405 and 407 and a second printer is used to perform step 419 to increase the speed of performing steps 405, 407 and 419.

At step 423, protect and release layer 109 or 309 is printed over the portion of scratch-off product 100 or 300 containing indicia 107 or 307. In a preferred embodiment, at step 423, protect and release layer 109 or 309 is printed over the entirety of scratch-off product 100 or 300. In one embodiment, protect and release layer 109 or 309 is printed using a flexographic plate and may be cured by convection, ultraviolet light or an electron beam.

In one embodiment, at step 425, upper opacity layer(s) 111 are printed over the portion of scratch-off product 100 containing indicia 107. In another embodiment, at step 425, upper opacity layer(s) 311 are printed over the entirety of scratch-off product 300. Upper opacity layers(s) 111 or 311 may be comprised of one or more layers of carbon black and/or one or more layers of process black. In a preferred embodiment, upper opacity layer(s) 111 or 311 are comprised of both carbon black and process black, effectively masking any color used for indicia 107 or 307. At step 427, the upper background layer(s) 113 or 313 are printed over upper opacity layer(s) 111 or 311, which may be comprised of white ink or colored ink.

In one embodiment, at step 429, overprint layer 115 is printed over background layer(s) 113 and display 117 is printed over substrate 101. In another embodiment, at step 429, overprint and display layer 315 is printed over background layer(s) 313 and extends across the entirety of scratch-off product 300. In one embodiment, one printer can be used to perform all of steps 425, 427 and 429 using inks having the same or a similar chemical composition as the printer used to perform steps 405, 407 and 419. In another embodiment, any number and any combination of flexographic plates, gravure cylinders and/or digital printers may be used to perform steps 425, 427 and 429. In a preferred embodiment, one printer is used to perform steps 425 and 427 and a second printer is used to perform step 429 to increase the speed of performing steps 425, 427 and 429.

At step 431, periodic perforations are stamped into substrate 101, 201 or 301 by a perforator to allow sets of tickets to be packaged and individually sold. The preferred embodiment has the advantage of using multiple digital printers and a single flexographic plate or gravure cylinder to print any scratch-off product. Although the flexographic plate or gravure cylinder for printing the protect and release layer 109, 209 or 309 is an analog process, printing protect and release layer 109, 209 or 309 across the entirety of scratch-off product 100, 200 or 300 allows the same flexographic plate or gravure cylinder to be used for any scratch-off product. In another embodiment, protect and release layer 109, 209 or 309 may be printed digitally. Accordingly, the preferred embodiment significantly reduces setup time by eliminating the need to change flexographic plates and/or gravure cylinders for printing different scratch-off products. Further, the preferred embodiment allows for printing different graphical images on different parts of the scratch-off product 100, 200 or 300 (e.g., the display, overprint, indicia, back of the substrate, etc.) during the same press run. The preferred embodiment also allows for printing a press run of scratch-off products, where each scratch-off product looks identical (similar to flexographic or gravure printing processes) or each scratch-off product looks different. The preferred embodiment further allows for shorter press runs as there is little to no setup time associated with the printing process (compared to the significant setup time associated with prior art flexographic and/or gravure printing processes that require printing at least 10 million or more copies of a scratch-off product in a single run).

One example of a press configuration for performing method steps 400 includes, but is not limited to, 4 Hewlett Packard (HP) Indigo 20000 series web presses one flexographic printer (e.g. TRESU or Harris-Bruno) and a perforator (e.g. Technifold). In one embodiment, the flexographic printer and perforator are capable of maintaining register or alignment with the web movement of the HP Indigo 20000 series web presses. However, any number of printers and/or types of printers can be used to perform method steps 400. For example, if scratch-off products 100, 200 or 300 are comprised of 20 layers, up to 20 printers could be used, where each printer prints a single layer.

Other objects, advantages and embodiments of the various aspects of the present invention will be apparent to those who are skilled in the field of the invention and are within the scope of the description and the accompanying Figures. For example, but without limitation, structural or functional elements might be rearranged, or method steps reordered, consistent with the present invention. Similarly, principles according to the present invention could be applied to other examples, which, even if not specifically described here in detail, would nevertheless be within the scope of the present invention.

What is claimed is:

1. A scratch-off product with enhanced security comprising:
a substrate;
indicia printed on a layer of the substrate;
a protect and release layer printed above the indicia;
a scratch-off coating printed above the protect and release layer, wherein
the scratch-off coating includes an upper opacity layer that has the same or a similar chemical composition as the indicia.

2. The scratch-off product with enhanced security of claim 1, wherein the substrate includes a lower opacity layer that covers the entirety of the substrate and the indicia has the same or a similar chemical composition as the lower opacity layer.

3. The scratch-off product with enhanced security of claim 1, wherein the protect and release layer covers the entirety of the substrate.

4. The scratch-off product with enhanced security of claim 1, wherein the upper opacity layer covers the entirety of the substrate.

5. The scratch-off product with enhanced security of claim 1, wherein the scratch-off coating further comprises an overprint layer printed above the upper opacity layer that has the same or a similar chemical composition as the indicia.

6. The scratch-off product with enhanced security of claim 1, further comprising a display layer that has the same or a similar chemical composition as the indicia.

7. The scratch-off product with enhanced security of claim 6, wherein the display layer is printed on the same layer as the overprint layer.

8. The scratch-off product with enhanced security of claim 6, wherein the display layer and the indicia are printed on the same layer.

9. The scratch-off product with enhanced security of claim 6, wherein the display layer is printed on the substrate.

10. The scratch-off product with enhanced security of claim 1, further comprising a layer printed on the backside of the substrate that has the same or a similar chemical composition as the indicia.

11. The scratch-off product with enhanced security of claim 1, wherein the indicia is comprised of a graphical image.

12. A method of printing a scratch-off product with enhanced security, the method comprising:
feeding a substrate into a printing press;
printing indicia on a layer of the substrate;
printing a protect and release layer above the indicia;
printing a scratch-off coating above the protect and release layer, wherein
the scratch-off coating includes an upper opacity layer that has the same or a similar chemical composition as the indicia.

13. The method of claim 12, further comprising, printing a lower opacity layer on the substrate and printing the indicia using the same or a similar chemical composition as the lower opacity layer.

14. The method of claim 12, further comprising, printing a layer on the backside of the substrate that has the same or a similar chemical composition as the indicia.

15. The method of claim 12, further comprising printing the protect and release layer to cover the entirety of the substrate.

16. The method of claim 12, further comprising printing the upper opacity layer to cover the entirety of the substrate.

17. The method of claim 12, further comprising printing an overprint layer above the upper opacity layer using the same or a similar chemical composition as the indicia.

18. The method of claim 13, further comprising printing a display layer above the lower opacity layer using the same or a similar chemical composition as the indicia.
